(19) United States
(12) Patent Application Publication
(10) Pub. No.: US 2014/0254049 A1
(43) Pub. Date: Sep. 11, 2014

(54) METHOD FOR ELIMINATING AN ARC DRIVEN BY MEANS OF AT LEAST ONE PHASE VOLTAGE SOURCE OF A CONVERTER CIRCUIT

(71) Applicant: ABB TECHNOLOGY AG, Zurich (CH)

(72) Inventors: Adrian GUGGISBERG, Wurenlingen (CH); John Eckerle, Basel (CH); Jonas Wahlstroem, Villnachern (CH)

(73) Assignee: ABB TECHNOLOGY AG, Zurich (CH)

(21) Appl. No.: 14/286,236

(22) Filed: May 23, 2014

Related U.S. Application Data
(63) Continuation of application No. PCT/EP2012/073360, filed on Nov. 22, 2012.

(30) Foreign Application Priority Data
Dec. 5, 2011 (EP) 11191935.3

(51) Int. Cl. H02H 7/125

(52) U.S. Cl. CPC H02H 7/1252
USPC 361/18

(57) ABSTRACT

A method for eliminating an arc driven by at least one phase voltage source of a converter circuit is disclosed. The converter circuit can include a converter unit and an energy storage circuit, wherein the at least one phase voltage source can be connected on an AC voltage side of the converter unit, and the converter unit can have a plurality of actuable power semiconductor switches. The method can include monitoring a state variable of the converter circuit for a predeterminable threshold value of the state variable to detect an arc, and actuating at least one of the plurality of actuable power semiconductor switches of the converter unit upon detecting a discrepancy between the state variable and the predeterminable threshold value.

### RELATED APPLICATION(S)

This application claims priority as a continuation application under 35 U.S.C. §120 to PCT/EP2012/073360, which was filed as an International Application on Nov. 22, 2012, designating the U.S., and claiming priority to European Application No. 11191935.3 filed in Europe on Dec. 5, 2011. The entire contents of these applications are hereby incorporated herein by reference in their entireties.

### FIELD

The disclosure relates to the field of power electronics, and a method for eliminating an arc driven by means of at least one phase voltage source of a converter circuit.

### BACKGROUND INFORMATION

Known converter circuits can have a converter unit, with at least two phase connections being provided on the AC voltage side of said converter unit, and which can be connected to phase voltage sources for providing a corresponding AC voltage to the phase connections. On the DC voltage side of the converter unit, the converter circuit can include an energy storage circuit, which can be formed by one or more capacitive energy stores, for example.

During operation of the converter circuit, for example, if electrical energy is flowing from the AC voltage side of the converter unit to the DC voltage side of the converter unit and the AC voltage can be rectified in the process, or if electrical energy is flowing from the DC voltage side of the converter unit to the AC voltage side of the converter unit and the DC voltage is being inverted in the process, as a result of a fault it can arise that an arc driven, in terms of current, by means of the phase voltage source occurs, for example, on the AC voltage side of the converter unit or else on the DC voltage side of the converter unit. Such an arc can damage or even destroy the converter unit, but also the entire converter circuit.

Mechanical switches can be used at the phase connections in order to short-circuit the phase voltage source or phase voltage sources. If an arc, which occurs, is detected in a converter circuit, the mechanical switches can be closed to short-circuit the phase voltage source or phase voltage sources to help eliminate the arc driven, in terms of current, by the phase voltage source or the phase voltage sources. However, such mechanical switches can have a slow response time, a large physical size, can need a high degree of maintenance and can increase the complexity of the design of the converter circuit.

As disclosed in DE 10 2009 002 684 A1, undesired arcs can also occur in a converter circuit for feeding a plasma load, wherein the arc can be generated by MF coils L1, L2 of the converter circuit, as described in DE 10 2009 002 684 A1 in paragraphs [0006] and [0007] in conjunction with FIG. 1a. To help eliminate an arc generated by the MF coils L1, L2 of the converter circuit, the polarity of the voltage at the output connections 13, 14 can be reversed, and wherein prior to this, the voltage can be set to a value in the region of OV and the current across the output connections 13, 14 can be set to a value in the region of 0 A. For example, the connected plasma load can be disconnected from the supply and deenergized, as described in DE 10 2009 002 684 A1, paragraph [0045].

### SUMMARY

A method is disclosed for eliminating an arc driven by at least one phase voltage source of a converter circuit, the converter circuit having a converter unit and an energy storage circuit, wherein the at least one phase voltage source is connected on an AC voltage side of the converter unit, and the converter unit has a plurality of actuable power semiconductor switches, the method comprising: monitoring a state variable of the converter circuit for a predeterminable threshold value of the state variable to detect an arc; and actuating at least one of the plurality of actuable power semiconductor switches of the converter unit upon detecting a discrepancy between the state variable and the predeterminable threshold value.

A method is disclosed for eliminating an arc driven by at least one phase voltage source of a converter circuit, the converter circuit having a converter unit and an energy storage circuit, wherein the at least one phase voltage source is connected on an AC voltage side of the converter unit, and the energy storage circuit is connected on a DC voltage side of the converter unit, and wherein the converter unit has a plurality of actuable power semiconductor switches, the method comprising: monitoring a surrounding environment of the converter circuit for an occurrence of an arc light, and actuating at least one of the plurality of actuable power semiconductor switches of the converter unit upon detecting the occurrence of the arc light.

### BRIEF DESCRIPTION OF THE DRAWINGS

The disclosure will now be further explained by way of exemplary embodiments and with reference to the accompanying drawings, in which:

FIG. 1 shows an exemplary embodiment of a converter circuit with illustrated short-circuiting current paths in accordance with a method according to the disclosure;

FIG. 2 shows an exemplary embodiment of a converter circuit with illustrated short-circuiting current paths in accordance with a method according to the disclosure;

FIG. 3 shows an exemplary embodiment of a converter circuit with illustrated short-circuiting current paths in accordance with a method according to the disclosure; and

FIG. 4 shows an exemplary embodiment of a converter circuit with illustrated short-circuiting paths in accordance with a method according to the disclosure.

### DETAILED DESCRIPTION

In accordance with an exemplary embodiment, a method for eliminating an arc driven by means of at least one phase voltage source of a converter circuit is disclosed, by which method an arc which occurs in a converter circuit can, for example, be eliminated relatively easily and quickly.

In accordance with an exemplary embodiment, the converter circuit can have a converter unit, at least one phase voltage source and an energy storage circuit, wherein the at least one phase voltage source can be connected on the AC voltage side of the converter unit. In addition, the converter unit can include a multiplicity of actuable power semiconductor switches. In accordance with the method, during operation the converter circuit detects an arc which occurs and, thereupon, the at least one phase voltage source can be short-circuited. In accordance with the disclosure, in order to detect the arc, a state variable of the converter circuit can be monitored for a predeterminable threshold value of the state variable. In the event of a discrepancy between the state variable and the predeterminable threshold value, at least some, for example, one or more, of the actuable power semiconductor switches of the converter unit can be actuated such that at least one short-circuiting path can be formed via the converter unit in order to short-circuit the at least one phase voltage source. By means of the abovementioned detection of an arc occurring and of the formation of at least one short-circuiting path via the converter unit, the arc which can occur can be quenched relatively easily and quickly and thus eliminated. In accordance with an exemplary embodiment, additional short-circuiting devices, such as known mechanical switches for short-circuiting the at least one phase voltage source, are not needed.

In accordance with an exemplary embodiment, the surrounding environment of the converter circuit can be monitored visually for the occurrence of an arc light, and wherein, in the event of the occurrence of the arc light, at least some of the actuable power semiconductor switches of the converter unit can be actuated in such a way that at least one short-circuiting path is formed via the converter unit in order to short-circuit the at least one phase voltage source. By means of this detection of an arc occurring and of the formation of at least one short-circuiting path via the converter unit, as well, the arc occurring can be quenched relatively easily and quickly and therefore eliminated. Additional short-circuiting devices are also not needed in this case either.

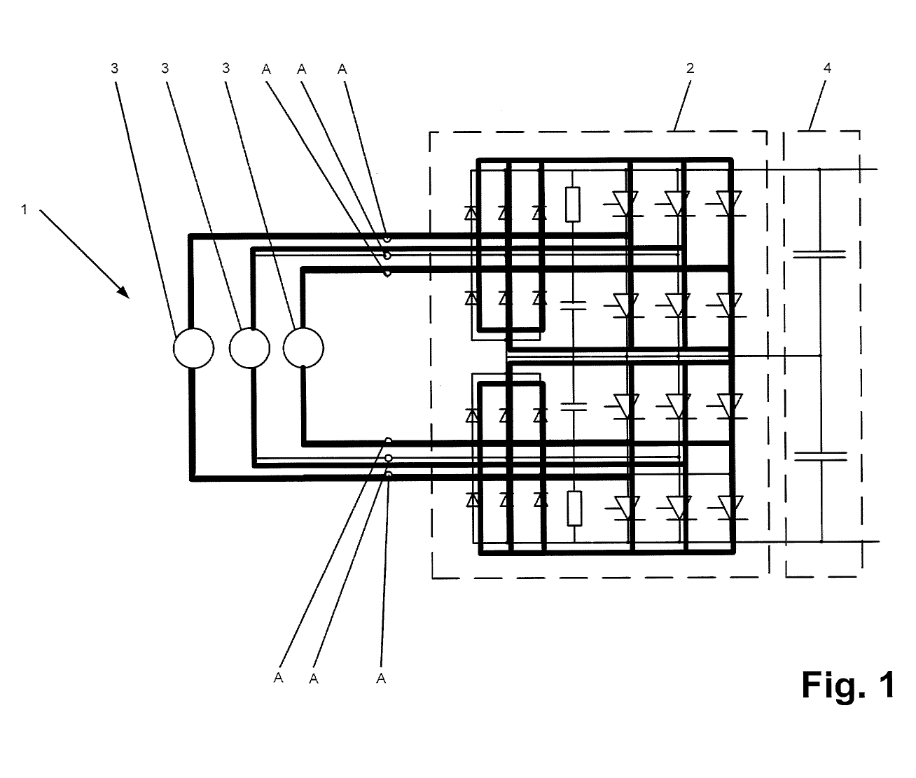

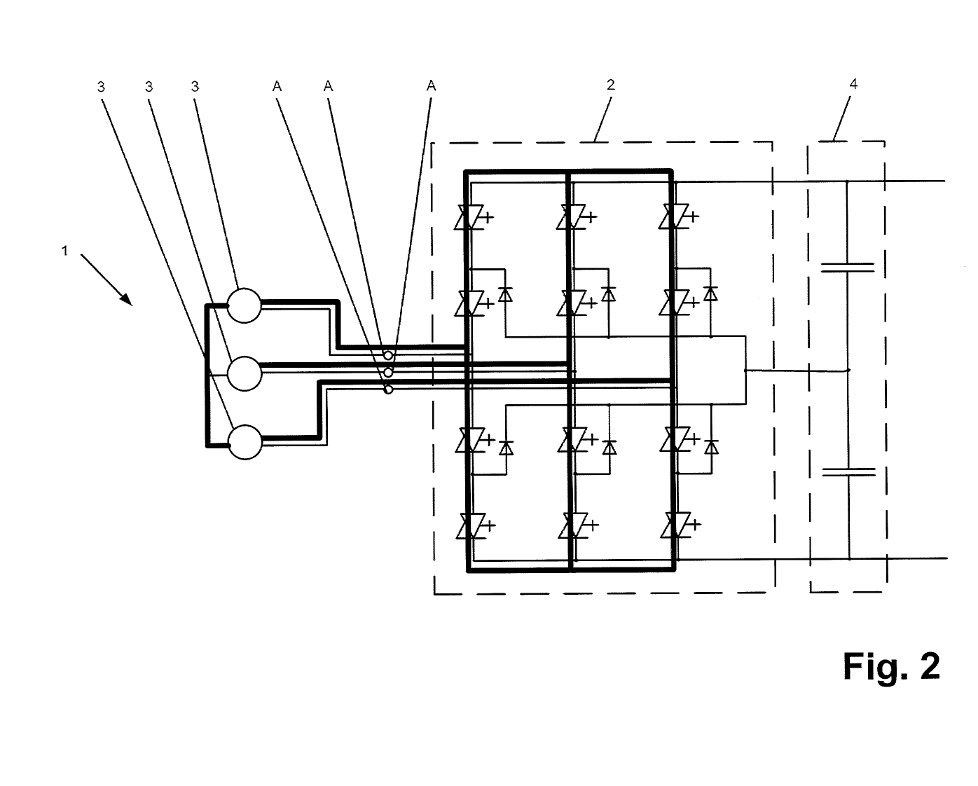

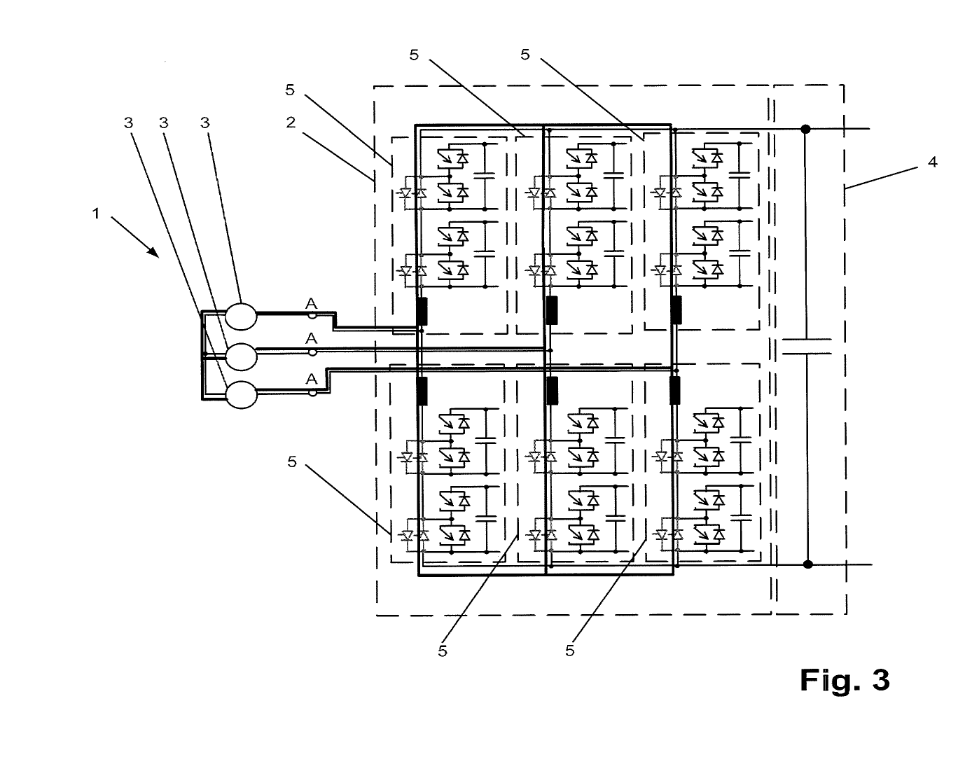

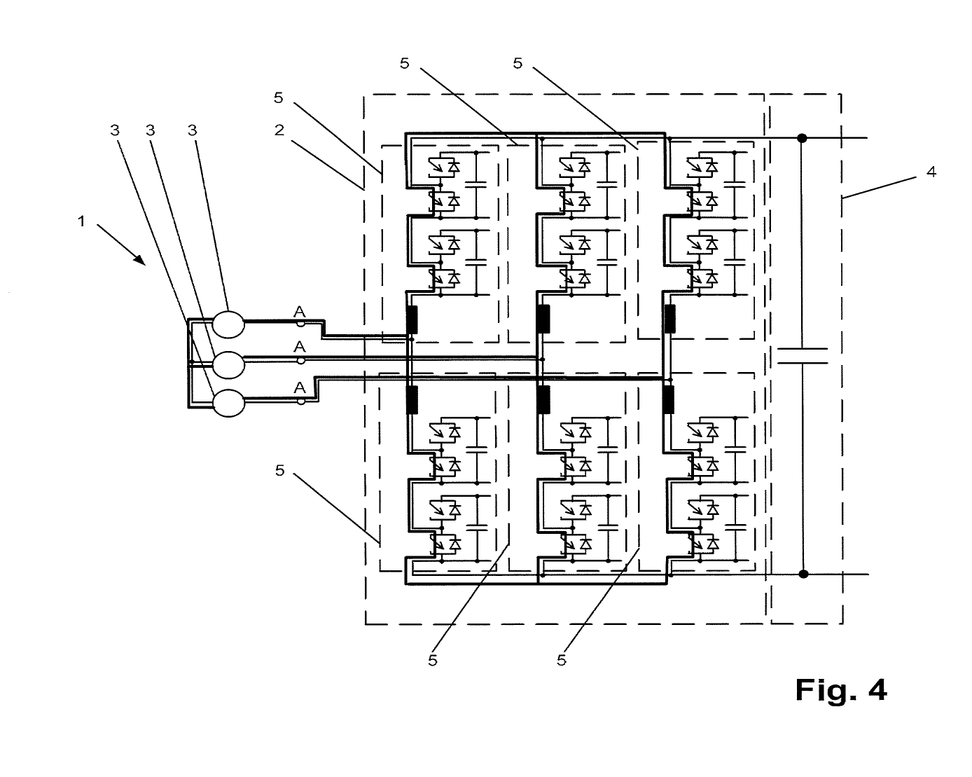

FIG. 1 shows an exemplary embodiment of a converter circuit with illustrated short-circuiting current paths in accordance with a method according to the disclosure. FIG. 2 to FIG. 4 show exemplary embodiments, respectively, of a converter circuit, wherein, in each of these converter circuits, short-circuiting paths in accordance with the method according to the disclosure can be illustrated. The respectively short-circuiting paths of the converter circuits shown in FIG. 1 to FIG. 4 can be illustrated as bold lines. In accordance with an exemplary embodiment, the converter circuit 1 can have a converter unit 2, at least one phase voltage source 3 and an energy storage circuit 4. The at least one phase voltage source 3 can be connected on the AC voltage side of the converter unit 2. The connection of the phase voltage source 3 can be performed at a phase connection A on the AC voltage side of the converter unit 2. Since the converter circuits shown in FIG. 1 to FIG. 4 all have a three-phase design, in each case three phase voltage sources 3 can also be provided, wherein, as already mentioned, at least one phase voltage source 3 can be provided. In addition, the converter unit 2 can have a multiplicity or plurality of actuable power semiconductor switches, wherein, for example, according to FIG. 1, thyristors can be used as actuable power semiconductor switches and, according to FIG. 2, integrated gate-commutated thyristors (IGCTs) can be used. In contrast, in the case of the converter circuit shown in FIG. 3, for example, insulated-gate bipolar transistors (IGBTs) and thyristors can be used as actuable power semiconductor switches, wherein the short-circuiting paths can run via the thyristors, as illustrated in FIG. 3. For example, in the case of the converter circuit shown in FIG. 4, IGCTs can be used as actuable power semiconductor switches, via which short-circuiting paths can run.

In accordance with an exemplary method, if an arc occurs during operation, the arc can be detected and, thereupon, the at least one phase voltage source 3 can be short-circuited. For example, such an arc can occur as a result of a fault, wherein the arc can be driven, in terms of current, by the at least one phase voltage source 3. In accordance with an exemplary embodiment, in order to detect the arc, a state variable of the converter circuit 1 can be monitored for a predeterminable threshold value of the state variable. In the event of a discrepancy between the state variable and the predeterminable threshold value, at least some of the actuable power semiconductor switches of the converter unit 2 can be actuated such that at least one short-circuiting path can be formed via the converter unit 2 in order to short-circuit the at least one phase voltage source 3. By means of the abovementioned detection of an arc occurring and of the formation of at least one short-circuiting path via the converter unit 2, the arc occurring can be quenched relatively easily and quickly and therefore eliminated. In accordance with an exemplary embodiment, additional short-circuiting devices can be dispensed with.

In accordance with an exemplary embodiment, to detect the arc, the surrounding environment of the converter circuit 1 can be monitored visually for the occurrence of an arc light, and wherein, in the event of the occurrence of the arc light, at least some, for example, one or more, of the actuable power semiconductor switches of the converter unit 2 can be actuated such that, at least one short-circuiting path can be formed via the converter unit 2 in order to short-circuit the at least one phase voltage source 3. For example, for the visual monitoring, a photodiode or another light-sensitive electronic component or else a camera can be used. By means of this detection of an arc occurring and of the formation of at least one short-circuiting path via the converter unit 2, the arc occurring can be quenched relatively easily and quickly and therefore eliminated. In addition, no additional short-circuiting devices are used.

In accordance with an exemplary embodiment, if an energy storage circuit 4 is connected on the DC voltage side of the converter unit, in relation to the converter circuit 1, as illustrated by way of example in FIG. 1 to FIG. 4, the state variable can be the voltage across the energy storage circuit 4 and the predeterminable threshold value of the state variable can be a predeterminable threshold value of the voltage across the energy storage circuit 4. The energy storage circuit can include one or more capacitive energy stores, such as capacitors, for example. In the event that the predeterminable threshold value of the voltage across the energy storage circuit 4 is undershot, at least some of the actuable power semiconductor switches of the converter unit 2 can be actuated such that at least one short-circuiting path can be formed via the converter unit 2 in order to short-circuit the at least one phase voltage source 3.

In accordance with an exemplary embodiment, as an alternative to the voltage across the energy storage circuit 4 as the state variable, the state variable can be the voltage at a phase connection A on the AC voltage side of the converter unit 2 and the predeterminable threshold value of the state variable can be a predeterminable threshold value of the voltage at a phase connection A on the AC voltage side of the converter unit 2. In the event that the predeterminable threshold value of the voltage at a phase connection A on the AC voltage side of the converter unit 2 is undershot, at least some of the actuable power semiconductor switches of the converter unit 2 can be actuated such that at least one short-circuiting path can be formed via the converter unit 2 in order to short-circuit the at least one phase voltage source 3.

In the case of a converter circuit as shown in FIG. 3 and FIG. 4, as an alternative to the voltage across the energy storage circuit 4 as state variable or as an alternative to the voltage at a phase connection A on the AC voltage side of the converter unit 2 as state variable, the state variable can be the voltage across a converter circuit element 5, as is illustrated in FIG. 3 and FIG. 4, of the converter unit 2 and the predeterminable threshold value of the state variable can be a predeterminable threshold value of the voltage across a converter circuit element 5. In the event of a discrepancy, for example in the event that the predeterminable threshold value of the voltage across a converter circuit element 5 is undershot, at least some of the actuable power semiconductor switches of the converter unit 2 can be actuated such that at least one short-circuiting path can be formed via the converter unit 2 in order to short-circuit the at least one phase voltage source 3.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 converter circuit
2 converter unit
3 phase voltage source
4 energy storage circuit
5 converter circuit element
A phase connection

What is claimed is:

1. A method for eliminating an arc driven by at least one phase voltage source of a converter circuit, the converter circuit having a converter unit and an energy storage circuit, wherein the at least one phase voltage source is connected on an AC voltage side of the converter unit, and the converter unit has a plurality of actuable power semiconductor switches, the method comprising:
monitoring a state variable of the converter circuit for a predeterminable threshold value of the state variable to detect an arc; and
actuating at least one of the plurality of actuable power semiconductor switches of the converter unit upon detecting a discrepancy between the state variable and the predeterminable threshold value.

2. The method as claimed in claim 1, wherein the actuating of the at least one of the plurality of actuable power semiconductor switches of the converter comprises:
forming at least one short-circuiting path via the converter unit to short-circuit the at least one phase voltage source.

3. The method as claimed in claim 2, comprising:
connecting the energy storage circuit on a DC voltage side of the converter unit; and wherein the state variable is a voltage across the energy storage circuit.

4. The method as claimed in claim 3, wherein the predeterminable threshold value of the state variable is a predeterminable threshold value of the voltage across the energy storage circuit.

5. The method as claimed in claim 4, comprising:
in an event that the predeterminable threshold value of the voltage across the energy storage circuit is undershot, actuating the at least one of the plurality of actuable power semiconductor switches of the converter unit.

6. The method as claimed in claim 1, wherein the state variable is the voltage at a phase connection on the AC voltage side of the converter unit, and the predeterminable threshold value of the state variable is a predeterminable threshold value of the voltage at a phase connection on the AC voltage side of the converter unit.

7. The method as claimed in claim 6, comprising:
in an event that the predeterminable threshold value of the voltage at a phase connection on the AC voltage side of the converter unit is undershot, actuating the at least one of the plurality of actuable power semiconductor switches of the converter unit.

8. The method as claimed in claim 1, wherein the plurality of actuable power semiconductor switches are thyristors, integrated gate-commutated thyristors (IGCTs), and/or insulated-gate bipolar transistors (IGBTs) and thyristors.

9. A method for eliminating an arc driven by at least one phase voltage source of a converter circuit, the converter circuit having a converter unit and an energy storage circuit, wherein the at least one phase voltage source is connected on an AC voltage side of the converter unit, and the energy storage circuit is connected on a DC voltage side of the converter unit, and wherein the converter unit has a plurality of actuable power semiconductor switches, the method comprising:
monitoring a surrounding environment of the converter circuit for an occurrence of an arc light; and
actuating at least one of the plurality of actuable power semiconductor switches of the converter unit upon detecting the occurrence of the arc light.

10. The method as claimed in claim 9, wherein the actuating of the at least one of the plurality of actuable power semiconductor switches of the converter comprises:
forming at least one short-circuiting path via the converter unit to short-circuit the at least one phase voltage source.

11. The method as claimed in claim 10, comprising:
visually monitoring a surrounding environment of the converter circuit for the occurrence of the arc light.

12. The method as claimed in claim 11, comprising:
using a photodiode, a light-sensitive electronic component, or a camera to visually monitor the surrounding environment.

13. The method as claimed in claim 9, wherein the plurality of actuable power semiconductor switches are thyristors, integrated gate-commutated thyristors (IGCTs), and/or insulated-gate bipolar transistors (IGBTs) and thyristors.
